(19) United States
(12) Patent Application Publication
(10) Pub. No.: US 2022/0019393 A1
(43) Pub. Date: Jan. 20, 2022

(54) IMAGE PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Makoto HAMADA, Kanagawa (JP)

(73) Assignee: FUJIFILM BUSINESS INNOVATION CORP., Tokyo (JP)

(21) Appl. No.: 17/177,380

(22) Filed: Feb. 17, 2021

(30) Foreign Application Priority Data
Jul. 15, 2020 (JP) 2020-121284

(51) Int. Cl. G06F 3/12

(52) U.S. Cl. CPC G06F 3/1273; G06F 3/1263; G06F 3/1259; G06F 3/1205

(57) ABSTRACT

An image processing apparatus includes a processor. The processor is configured to perform control for displaying executed jobs as a job history list together with images uniquely indicating the jobs, such that identical images are displayed for jobs with identical set values with respect to a predetermined setting item, each of the executed jobs constituting a job history.

### CROSS-REFERENCE TO RELATED APPLICATIONS

This application is based on and claims priority under 35 USC 119 from Japanese Patent Application No. 2020-121284 filed Jul. 15, 2020.

### BACKGROUND

### (i) Technical Field

The present disclosure relates to image processing apparatuses and non-transitory computer readable media.

### (ii) Related Art

Japanese Unexamined Patent Application Publication No. 2019-135814 discloses an image forming apparatus that displays a list of executed jobs on a screen of an operation panel in a selectable manner. A user selects any of the executed jobs so that, without having to perform the same setting operation as that for the relevant executed job, a new job is executable with the same settings as the executed job.

### SUMMARY

Aspects of non-limiting embodiments of the present disclosure relate to an image processing apparatus that achieves enhanced findability of a desired job from a displayed history list of multiple jobs, as compared with a case where a history list of executed jobs is displayed as text information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus including a processor. The processor is configured to perform control for displaying executed jobs as a job history list together with images uniquely indicating the jobs, such that identical images are displayed for jobs with identical set values with respect to a predetermined setting item, each of the executed jobs constituting a job history.

### BRIEF DESCRIPTION OF THE DRAWINGS

Exemplary embodiments of the present disclosure will be described in detail based on the following figures, wherein:

FIG. 1 illustrates a hardware configuration of a multifunction apparatus according to an exemplary embodiment of the present disclosure;

FIG. 2 is a functional block diagram of the multifunction apparatus according to the exemplary embodiment of the present disclosure;

FIG. 3 illustrates an example of a job history of the multifunction apparatus according to the exemplary embodiment of the present disclosure;

FIG. 4 illustrates an example of a job history management list in the exemplary embodiment of the present disclosure;

FIG. 5 is a flowchart illustrating a process performed in the multifunction apparatus according to the exemplary embodiment of the present disclosure;

FIG. 6 is a flowchart continuing from section A in FIG. 5;

FIG. 7 illustrates an example of a menu screen displayed on a user interface device of the multifunction apparatus;

FIG. 8 illustrates an example of a copy function setting screen displayed on the user interface device of the multifunction apparatus;

FIG. 9 illustrates an example of a job history display screen displayed on the user interface device of the multifunction apparatus;

FIG. 10 illustrates an example of a re-execution job selection screen displayed on the user interface device of the multifunction apparatus;

FIG. 11 illustrates an example of a confirmation screen displayed on the user interface device of the multifunction apparatus when a new job is executed;

FIG. 12 illustrates an example of a confirmation screen displayed on the user interface device of the multifunction apparatus when a job is re-executed;

FIG. 13A illustrates the display order of executed jobs when the descending number of re-executions is set as a first priority, and FIG. 13B illustrates the display order of executed jobs when the descending number of changed setting items is set as a first priority;

FIG. 14A illustrates an example of a confirmation message displayed on the user interface device in a first specific example of operation, and FIG. 14B illustrates an example of a job history display screen;

FIG. 15A illustrates an example of a confirmation message displayed on the user interface device in a second specific example of operation, and FIG. 15B illustrates an example of a job history display screen;

FIG. 16A illustrates an example of a confirmation message displayed on the user interface device when a job is executed by changing a set value in the second specific example of operation, and FIG. 16B illustrates an example of a job history display screen; and

FIG. 17A illustrates an example of a confirmation message displayed on the user interface device in a third specific example of operation, and FIG. 17B illustrates an example of a job history display screen.

### DETAILED DESCRIPTION

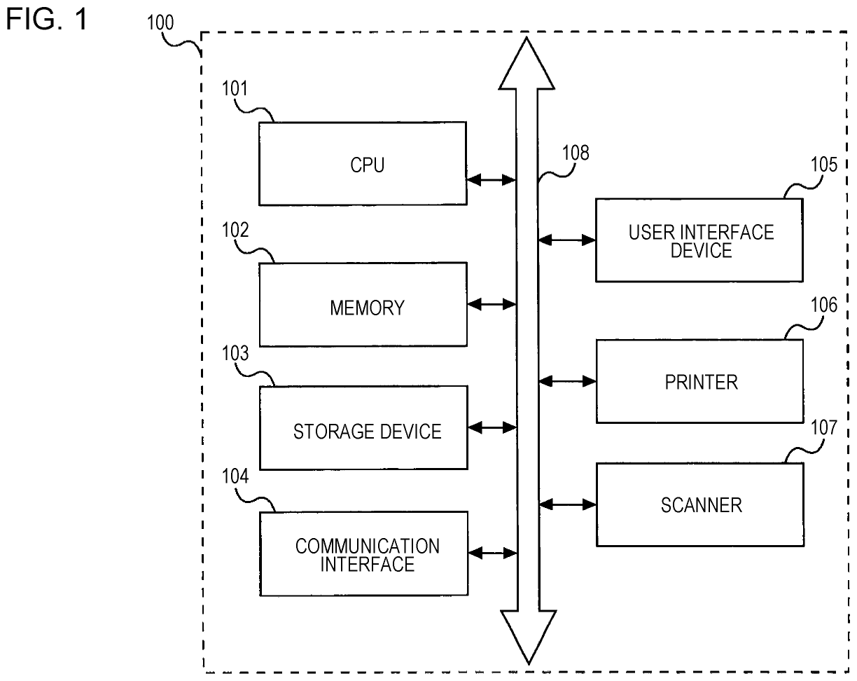

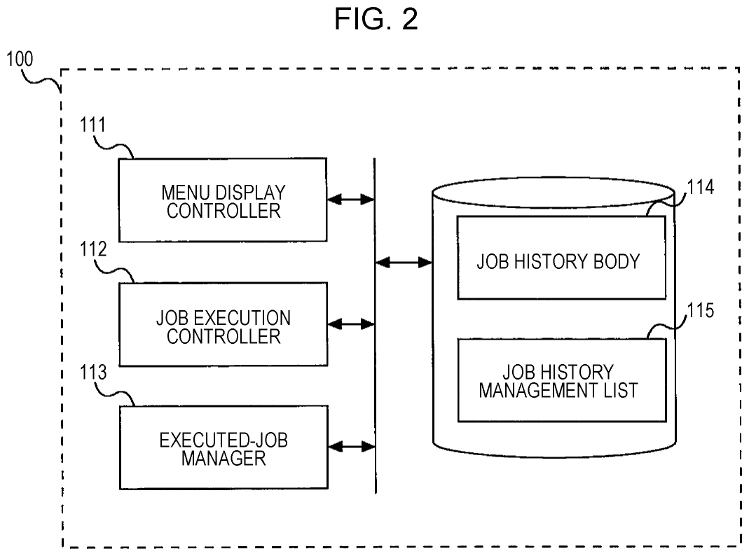

A case where an image processing apparatus according to an exemplary embodiment of the present disclosure is applied to a multifunction apparatus 100 will be described as an exemplary embodiment with reference to the drawings. The following exemplary embodiment of the present disclosure is related to an image processing apparatus as an example and is not intended to limit the present disclosure to the following exemplary embodiment. FIG. 1 illustrates a hardware configuration of the multifunction apparatus 100, and FIG. 2 is a functional block diagram of the multifunction apparatus 100.

The multifunction apparatus 100 has a central processing unit (CPU) 101, a memory 102, a storage device 103, a communication interface 104, a user interface device 105, a printer 106, and a scanner 107 that are connected to a control bus 108.

The CPU 101 is a control microprocessor that controls the operation of each component of the multifunction apparatus 100 based on a control program stored in the storage device 103.

The memory 102 temporarily stores image data to be printed by the printer 106 of the multifunction apparatus 100, as well as image data scanned by the scanner 107. Moreover, the memory 102 temporarily stores information received from a computer terminal (not shown) or a server (not shown) connected to the multifunction apparatus 100, as well as set values of setting items with respect to various functions changed by the user when a job is executed.

The storage device 103 is constituted of a hard disk drive (abbreviated as “HDD”) or a solid state drive (abbreviated as “SSD”) and stores a control program for controlling each component of the multifunction apparatus 100. The storage device 103 stores therein setting information about an executed job executed by the multifunction apparatus 100, a job history body, to be described later, and a job-history-display management list.

The communication interface 104 is connected to a server (not shown), a computer terminal (not shown), or another multifunction apparatus (not shown) by a network and communicates therewith via a local-area-network (LAN) cable (not shown) or a wireless LAN. Moreover, the communication interface 104 is connected to a telephone line and exchanges facsimile data with another multifunction apparatus (not shown) or a facsimile apparatus (not shown).

The user interface device 105 is an input-output device constituted of a liquid crystal display and a touchscreen provided in the multifunction apparatus 100, and displays various types of screens on the liquid crystal display and receives an operation performed on the touchscreen by a user, thereby receiving information corresponding to the received operation performed by the user. In addition to the touchscreen, the user interface device 105 may include a mechanical input device, such as an input keyboard and buttons additionally provided in the multifunction apparatus 100.

The printer 106 prints, on a sheet, an image transmitted from the computer terminal connected to the multifunction apparatus 100 by the network. The scanner 107 reads a document placed on a document tray, converts the read data into image data, and stores the image data in the memory 102. The image data temporarily stored in the memory 102 is printed onto a sheet by the printer 106, is transmitted to the computer terminal connected to the multifunction apparatus 100 via the network, is transmitted to another multifunction apparatus or a facsimile apparatus via the telephone line, or is stored in the storage device 103 of the multifunction apparatus 100. Detailed descriptions of the printer 106 and the scanner 107 will be omitted here.

As shown in FIG. 2, the multifunction apparatus 100 causes the CPU 101 to execute the control program stored in the storage device 103 so as to exhibit functions of a menu display controller 111, a job execution controller 112, and an executed-job manager 113, and also controls a job history body 114 and a job history management list 115.

The menu display controller 111 causes the liquid crystal display of the user interface device 105 in the multifunction apparatus 100 to display a menu screen including multiple function buttons, and also to display a job history display screen. Specifically, with regard to executed jobs constituting a job history, to be described later, if there are jobs with identical set values with respect to a predetermined setting item, the job history display screen displays a job history list together with images uniquely indicating the jobs such that identical images are displayed for such jobs. In other words, in the job history display screen, if a setting item other than the predetermined setting item has different set values even when the function is the same, different images are displayed. In this case, a setting item refers to an item that allows a set value for a function to be changeable by a user prior to execution or re-execution of a job. A predetermined setting item refers to a specific setting item set in advance by a mechanical manager, and specifically includes a setting item that is frequently changed by a user and a readily-changeable setting item. A set value refers to a changeable value set for each setting item for controlling the operation when the corresponding function is executed.

When the user selects any of the function buttons displayed on the liquid crystal display of the user interface device 105 in the multifunction apparatus 100, confirms or changes the set values, and then selects a start button, the job execution controller 112 executes the job corresponding to the selected function button. Furthermore, when the user selects a specific executed-job history from the job history display screen displayed on the liquid crystal display of the user interface device 105, confirms the set values, and selects the start button, the job execution controller 112 re-executes the job corresponding to the job history. In this description, the term “job” refers to a series of process units for realizing one function in the multifunction apparatus 100, such as a copying process executed based on a user's command, a scanning process, or a process for transmitting or storing a scanned document.

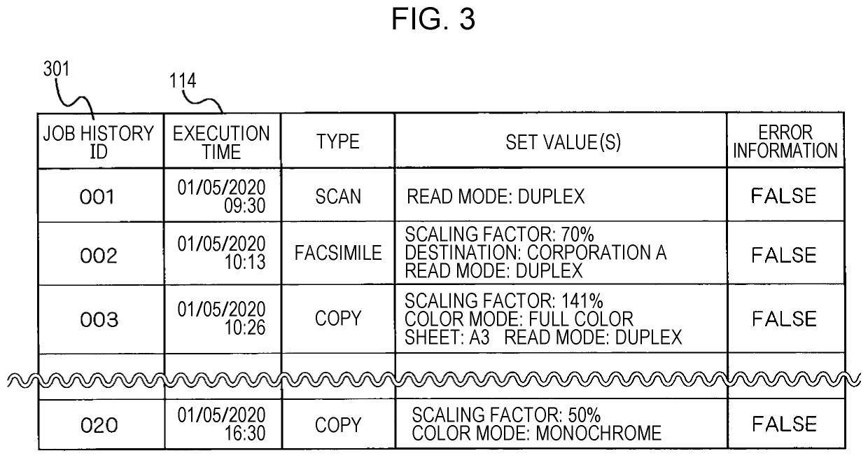

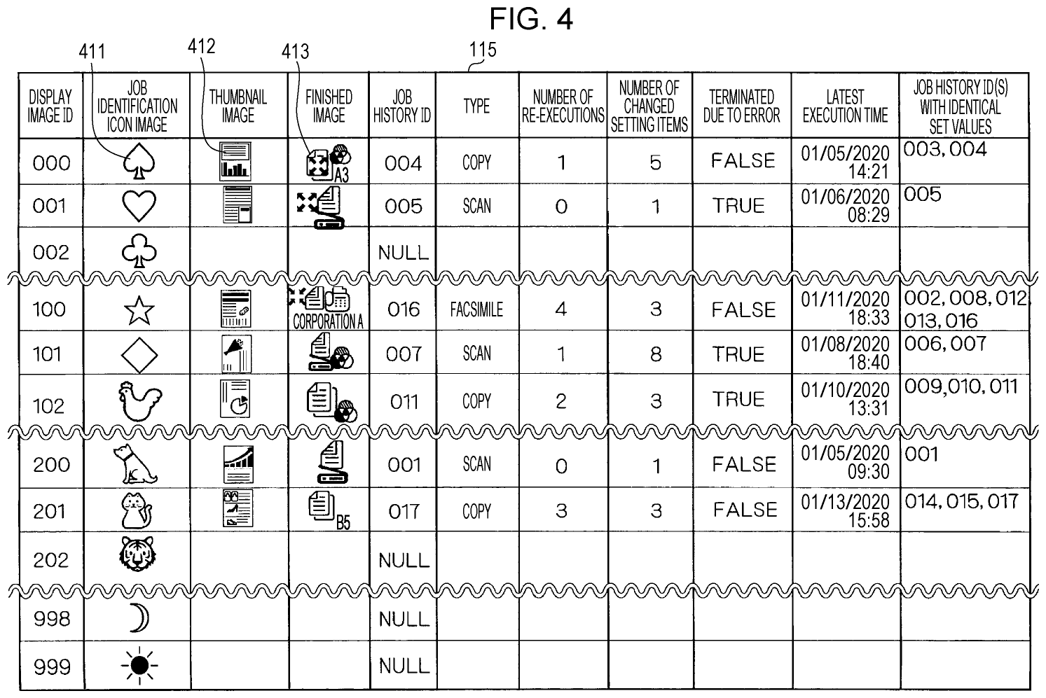

The executed-job manager 113 generates the job history body 114 shown in FIG. 3 and the job history management list 115 shown in FIG. 4, stores the job history body 114 and the job history management list 115 in the storage device 103, and changes and updates the contents of the job history body 114 and the job history management list 115. Every time a job is executed in the multifunction apparatus 100, the executed-job manager 113 allocates a job history ID to the executed job and stores the execution time of the job, the type of the job, the set values of the setting items, and error information in the job history body 114 in association with the job history ID. With regard to the set values stored in the job history body 114, only set values that have been changed from initial values may be stored therein.

In the job history body 114 in FIG. 3, job history IDs “001” to “020” are set in a job history ID field 301. Each job history ID set in the job history ID field 301 is an ID uniquely allocated to an executed job every time a job is executed, and is normally allocated in the executed sequence, but may alternatively be an ID randomly allocated so as not to be redundant with other jobs. For example, a job history ID “001” is associated with “01/05/2020 09:30” as a job execution time, “scan” as a job type, “duplex read” as a set value for a read mode, and “FALSE”, that is, no error, as error information.

The job history management list 115 in FIG. 4 is created and updated by the executed-job manager 113 based on the job history body 114 in FIG. 3. In the job history management list 115, a job history that corresponds to any of the following has been excluded from the job history body 114. Specifically, examples of such a job history include (1) a job history of a newer job with set values that are all identical to those of another job, (2) a job history of a job with set values that have not been changed from the initial values, (3) a job history of a job selected so as not to be re-executed based on user's intention, as will be described later, and (4) a job history of a job associated with all managed display image IDs and being an older job among jobs not corresponding to the aforementioned conditions (1) to (3), that is, a job executed at the oldest time point from the current time point and re-executed less frequently.

The executed-job manager 113 creates the job history management list 115 by excluding a job or jobs corresponding to any of the aforementioned conditions (1) to (4). In FIG. 4, each of display image IDs “000” to “999” serves as a principal key and is associated with a job identification icon image, a thumbnail image, a finished image, a job history ID, a job type, the number of re-executions, error information, the latest execution time, and a job history ID or IDs with identical set values.

Each display image ID in the job history management list 115 is an ID uniquely allocated to a job identification icon image 411 to be described below. In this exemplary embodiment, a job identification icon image 411 is a simplified image of a shape or mark unrelated to the type or contents of an executed job and is readily remembered by a user. For example, in this exemplary embodiment, a display image ID “000” is associated with an image of a “spade” mark as a job identification icon image 411. Each job identification icon image 411 used may be a symbol, such as a “heart” mark, a “clover” mark, a “diamond” mark, or a “star” mark, in addition to the “spade” mark, or a simplified image of an animal, a vehicle, a building, an activity, or an event. Furthermore, by varying the image color and the image orientation for each display image ID, the user may recognize different images.

In this exemplary embodiment, the image shape or mark is unrelated to the type or contents of an executed job. Alternatively, in a case of jobs of partially identical types or contents, the same shape, image, color, and/or orientation may be used. For example, a “spade” mark may be used uniformly when the job type is “copy”, a “heart” mark may be used uniformly when the job type is “scan”, and the color and the orientation of the “spade” mark and the “heart” mark may be varied when the set values vary.

As another alternative, an image type or a group may be allocated to each job type, as in using an image of a symbol when the job type is “copy” and using an image of an animal when the job type is “print”. Needless to say, an image with the same orientation and the same color may be used for indicating that the job type and contents are the same. These job identification icon images 411 may be stored in advance in the storage device 103, or may be acquired by the multifunction apparatus 100 from a server (not shown) connected to the multifunction apparatus 100, where appropriate.

In the job history management list 115 in FIG. 4, each display image ID serves as a principal key. Therefore, the same job identification icon image 411 is not used for executed jobs other than jobs with identical set values, whereas this job identification icon image 411 is used for uniquely indicating jobs having identical set values. Specifically, as a job identification icon image 411 uniquely indicating a single executed job or jobs having identical set values, a job identification icon image 411 used for another job or for another job history with different set values is prohibited from being displayed as the history of the job.

Each thumbnail image 412 in the job history management list 115 is a sample image of a reduced document image when the corresponding job is executed. In FIG. 4, the display image ID “000” is associated with a reduced document image, including a graph, as a thumbnail image 412. With regard to each of these thumbnail images 412, if a document is scanned, copied, or transmitted by facsimile by using the scanner 107, since image data of the scanned document is temporarily stored in the memory 102, a reduced version of the image is used. If an image or a document is received from a computer terminal and is printed out, a thumbnail image 412 is generated by using the received image or document data.

Each finished image 413 in the job history management list 115 is an abstracted image obtained by abstracting the setting contents of a job. In FIG. 4, the display image ID “000” is associated with an image that abstractly expresses a copying function, a full-color setting, duplex printing, and enlarged printing as a finished image 413. Alternatively, for example, each finished image 413 used may be obtained by abstracting and combining a job type, such as copying, scanning, or facsimile transmission, and the setting contents of each job, including a read/print mode, such as a simplex or duplex mode, a color or monochrome setting, a setting for when multiple pages are printed onto a single sheet.

In the job history management list 115 in FIG. 4, the job identification icon images 411, the thumbnail images 412, and the finished images 413 are examples displayed in association with actual images for providing an easier understanding of the concepts thereof. However, these images may be stored in the storage device 103 separately from the job history management list 115, and may be stored in association with uniform resource locators (URLs) where the corresponding files are stored.

Furthermore, in the job history management list 115 in FIG. 4, multiple images, such as a job identification icon image 411, a thumbnail image 412, and a finished image 413, are associated with one another as images uniquely indicating each executed job, and are displayed together on the job history display screen, to be described later. Alternatively, as will be described later in first and second specific examples of operation, the job identification icon image 411 alone may be used, or a combination of the job identification icon image 411 and at least one of the thumbnail image 412 and the finished image 413 may be used. In a third specific example of operation to be described later, the job identification icon image 411 and the thumbnail image 412 are associated with each other.

With regard to each job history ID in the job history management list 115, the job history ID of a job with the latest execution time from the current time point among executed jobs with identical set values is associated with the corresponding display image ID.

Each job type in the job history management list 115 indicates which of the functions of the multifunction apparatus 100, such as the copying function, the scanning function, and the facsimile transmission function, has been used in the job associated with the corresponding display image ID. In FIG. 4, the display image ID “000” is associated with “copy” as a job type.

The number of re-executions in the job history management list 115 indicates the number of times a user has selected an executed job from the job history display screen, to be described later, and has re-executed the selected job as a new job. In FIG. 4, the display image ID “000” is associated with “1” as the number of re-executions. In this exemplary embodiment, the term “re-execute” refers to an example in which a case where a job with the same set values is executed again is counted as “1” as the number of re-executions. Alternatively, instead of the number of re-executions, the total number of executions may be counted when a job with the same set values is re-executed. In that case, the number of executions in the above example is “2”. In either case, it is regarded that a job is re-executed if the set values are the same even when the document is not exactly identical.

The number of changed setting items in the job history management list 115 is the stored number of setting items when a user changes the setting items of the multifunction apparatus 100 from the initial values. In this case, a setting item is an item with a set value changeable by a user prior to execution of a job, such as a scaling factor, a sheet type, a color mode, an image quality, or a read mode. In FIG. 4, the display image ID “000” has “5” set therefor as the number of changed setting items. This indicates that set values have been changed from the initial values with respect to five setting items.

With regard to terminated-due-to-error information in the job history management list 115, a value “FALSE” is set when the execution of a job is properly completed, and a value “TRUE” is set when the execution of a job is not properly completed. In FIG. 4, the value “FALSE” is set as the terminated-due-to-error information with respect to the display image ID “000”. This indicates that an error has not occurred when the corresponding job is executed, that is, the job has been properly completed with no errors.

With regard to the latest job execution time in the job history management list 115, the date and the time of the last execution of a job associated with a display image ID are recorded. In FIG. 4, “01/05/2020 14:21” is set as the latest job execution time with respect to the display image ID “000”.

With regard to redundant job information in the job history management list 115, job history IDs of multiple jobs with identical set values are stored if the multiple jobs are associated with a single display image ID. In FIG. 4, redundant job history IDs “003, 004” are associated with the display image ID “000”.

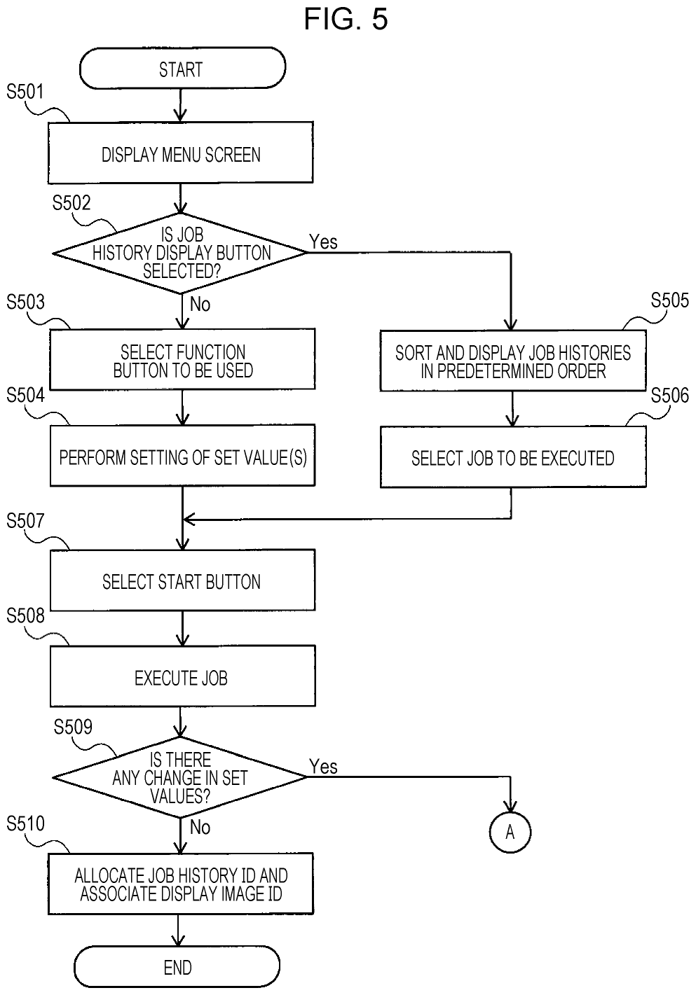

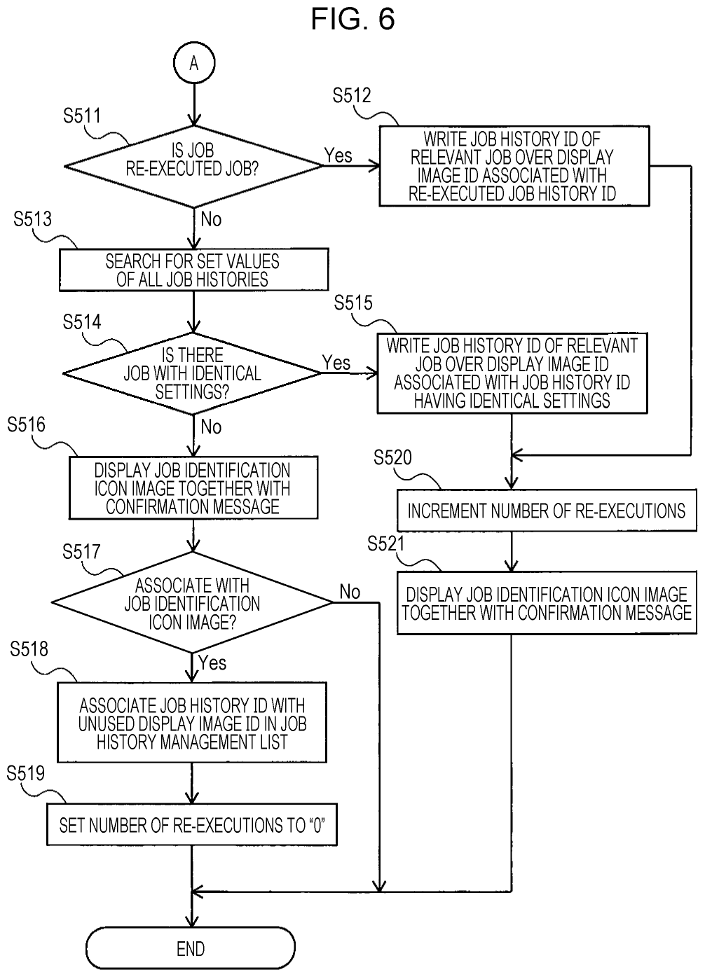

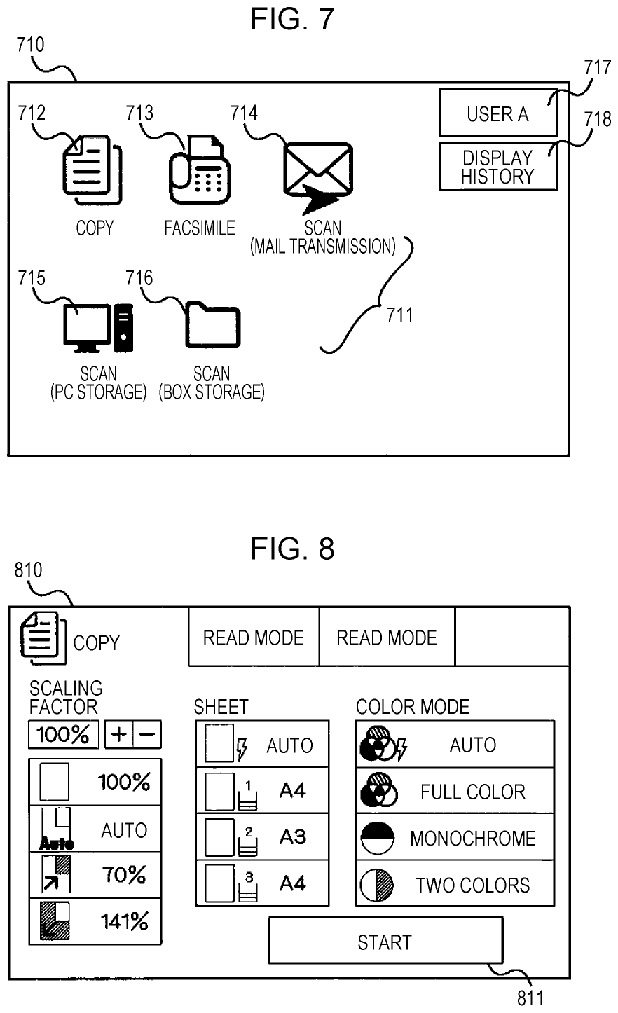

Next, the operation of the multifunction apparatus 100 will be described with reference to FIGS. 5 to 12. FIG. 5 is a flowchart illustrating an example of a process performed in the multifunction apparatus 100. FIG. 6 is a flowchart continuing from section A in FIG. 5. In step S501 in FIG. 5, the menu display controller 111 displays a menu screen 710 as shown in FIG. 7 on the user interface device 105. The menu screen 710 displays various function buttons 711, a log-in information display field 717, and a job history display button 718. The various function buttons 711 include a copy setting button 712, a fax setting button 713, a scan mail-transmission setting button 714, a scan PC-storage setting button 715, and a scan box-storage setting button 716.

In step S502, the menu display controller 111 determines whether or not the job history display button 718 is selected by a user. If the job history display button 718 is selected, the process proceeds to step S505. If not, the process proceeds to step S503.

In step S503, the menu display controller 111 determines whether any of the various function buttons 711 is selected by the user, and displays a function setting screen corresponding to the selected function on the user interface device 105. For example, if the user selects the copy setting button 712, the menu display controller 111 displays a copy function setting screen 810 as shown in FIG. 8 on the user interface device 105. The copy function setting screen 810 displays a set value for each setting item in a changeable manner.

In step S504, the user changes the set value for each setting item from the initial value on the function setting screen by operating the user interface device 105. For example, the user changes setting items, such as the “scaling factor”, “sheet size”, “color mode”, and “read mode”, and the process proceeds to step S507.

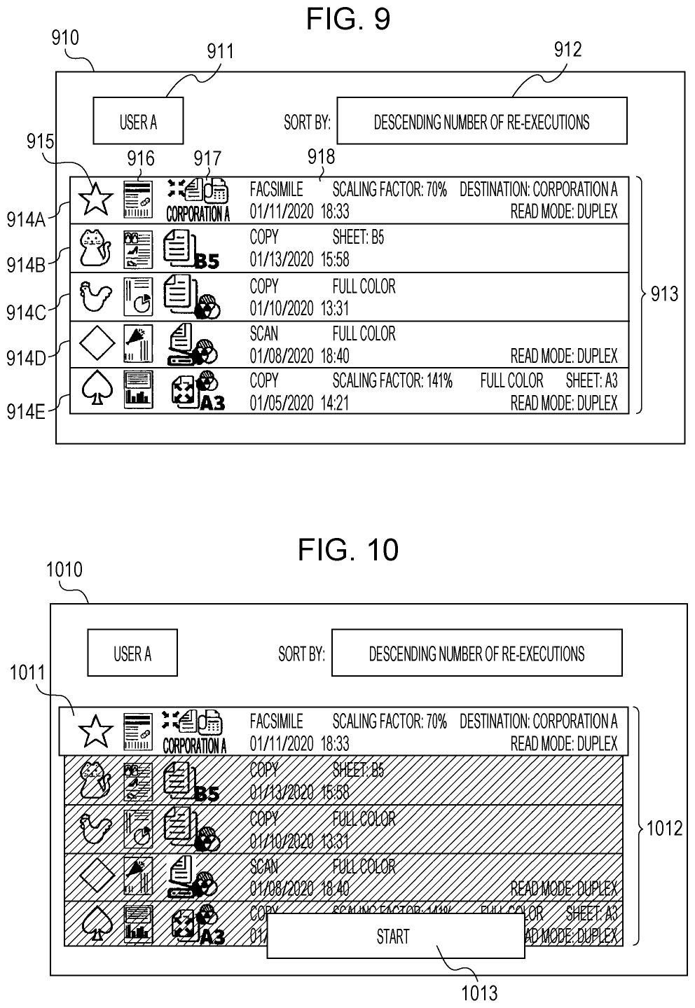

On the other hand, if it is determined in step S502 that the job history display button 718 is selected, the process proceeds to step S505 where the executed-job manager 113 sorts the job histories in accordance with a predetermined priority-order determination rule set based on the job history management list 115 stored in the storage device 103, and the menu display controller 111 displays a sorted job history display screen 910 as shown in FIG. 9 on the user interface device 105.

The job history display screen 910 in FIG. 9 includes a log-in username display field 911, a sort-order display field 912, and a job history display field 913. The log-in username display field 911 displays information about a user, such as “user A”, currently logged in for operating the multifunction apparatus 100. The sort-order display field 912 displays the priority-order determination rule for the sorting executed in step S505. For example, in FIG. 9, “descending number of re-executions” is displayed as the sort order. In the job history display field 913, multiple individual job histories 914A to 914D are displayed such that jobs that are re-executed more frequently are prioritized.

For example, the job history 914A constituting the job history display field 913 in FIG. 9 displays job information corresponding to a display image ID “100” in the job history management list 115 in FIG. 4. The individual job histories 914A to 914D each include a job identification icon image 915 as an image uniquely indicating an executed job, a thumbnail image 916 as a sample image obtained by reducing a document when the job is executed, a finished image 917 as an abstracted image of the setting contents of the job, and a job content display field 918.

For example, in FIG. 9, the job history 914A displayed includes a “star” image as the job identification icon image 915, an image of a facsimile document as the thumbnail image 916, and a combination of a facsimile-suggesting image and an image suggesting a document having text on both faces thereof as the finished image 917. Furthermore, the job content display field 918 displays “facsimile” as the job type, “01/11/2020 18:33” as the latest job execution time, “70%” as the scaling factor, “Corporation A” as the destination, and “duplex” as the read mode.

In step S506, the user selects a job to be re-executed while referring to the job history display screen 910. When the user selects a job to be re-executed, the menu display controller 111 displays a re-execution job selection screen 1010 as shown in FIG. 10. In the re-execution job selection screen 1010 in FIG. 10, the executed job selected by the user is highlighted in a selected mode 1011, and a start button 1013 is displayed below a job history display field 1012. The process then proceeds to step S507. At this time, a function setting screen with the set values for the executed job reflected therein may be displayed such that the set values are changeable.

In step S507 subsequent to step S504 and step S506, the user selects a start button 811 shown in the copy function setting screen 810 in FIG. 8 or the start button 1013 shown in the re-execution job selection screen 1010 in FIG. 10. In step S508, the job execution controller 112 stores the contents of the set values changed from the initial values and the number of setting items in the memory 102, and executes the job based on the set values.

In step S509, the executed-job manager 113 determines whether or not the executed job has a setting item changed from an initial value, that is, whether or not there is a change in any of the set values. If there is no setting item changed from an initial value, the process proceeds to step S510 where the executed-job manager 113 allocates a job history ID to the executed job, designates a job type to the job history ID, and stores the job history ID in the job history body 114 of the storage device 103. In this case, the executed-job manager 113 ends the process without associating a display image ID with the job history ID.

If it is determined in step S509 that there is a change in any of the set values in the executed job, the process proceeds to step S511 in FIG. 6. In step S511, the executed-job manager 113 determines whether or not the executed job is a re-executed job, that is, a job executed by being selected from the job history display screen 910 described with reference to FIG. 9. If it is determined that the executed job is a re-executed job, the process proceeds to step S512 where the executed-job manager 113 associates the job history ID of the relevant job with the display image ID associated with the re-executed job history ID, that is, performs updating. The process then proceeds to step S520. With regard to the term “updating”, because a display image ID is already associated with a different job history ID when a job is re-executed, the job history ID is replaced with the job history ID of the currently-executed job. If it is determined in step S511 that the executed job is not a re-executed job, the process proceeds to step S513.

In step S513, the executed-job manager 113 searches for the set values of all the executed jobs in the job history body 114 stored in the storage device 103. In step S514, the executed-job manager 113 determines whether or not there is a job with set values identical to those of the relevant job. If it is determined that there is a job with identical set values, the process proceeds to step S515 where the executed-job manager 113 associates the job history ID of the relevant job with the display image ID associated with the job history ID having the identical set values, included in the job history management list 115, that is, performs updating. The process then proceeds to step S520.

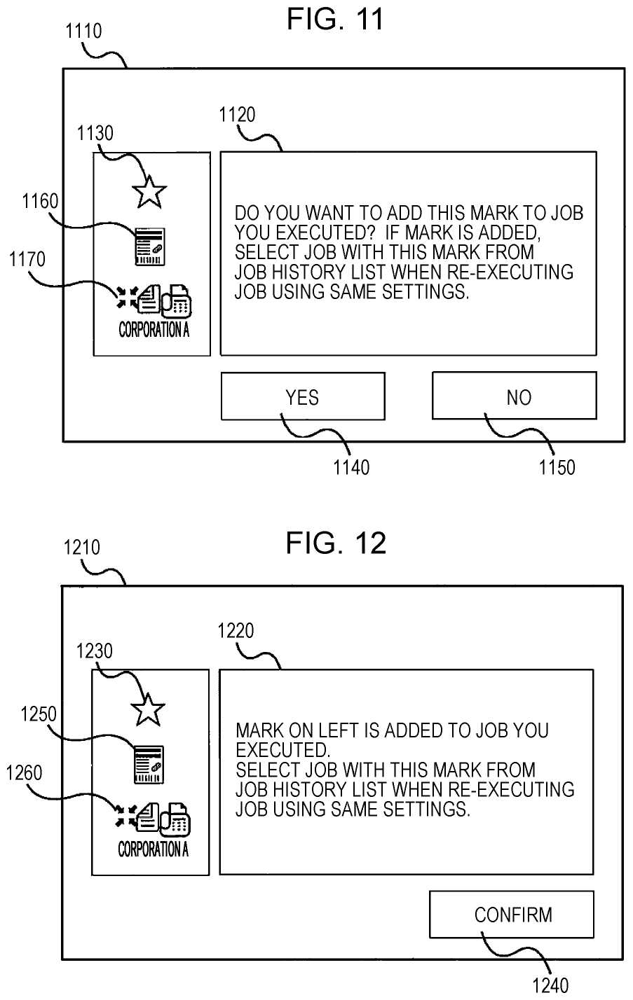

In contrast, if it is determined in step S514 that there is no job with identical set values, the process proceeds to step S516 where the menu display controller 111 randomly selects a job identification icon image from multiple different job identification icon images in the job history management list 115 such that the selected job identification icon image is not redundant with job identification icon images allocated to other jobs, and then displays a confirmation screen 1110 as shown in FIG. 11 on the user interface device 105. The confirmation screen 1110 displays, for example, a confirmation message 1120 reading “DO YOU WANT TO ADD THIS MARK TO JOB YOU EXECUTED? IF MARK IS ADDED, SELECT JOB WITH THIS MARK FROM JOB HISTORY LIST WHEN RE-EXECUTING JOB USING SAME SETTINGS.”, an unused job identification icon image 1130, such as a star mark, selected from the job history management list 115, a “YES” button 1140, and a “NO” button 1150. The process then proceeds to step S517 where an input of selection of whether or not a job identification icon image as an image uniquely indicating the relevant job is to be added is received from the user.

Furthermore, in this case, the executed-job manager 113 generates a thumbnail image 1160 and a finished image 1170, and the menu display controller 111 displays these images in addition to the job identification icon image 1130.

In step S517, when the user selects the “YES” button 1140 on the confirmation screen in FIG. 11, that is, when the user approves that the job identification icon image is to be associated with the executed job, the process proceeds to step S518 where the job history management list 115 associates the job history ID of the relevant job, the job type, the number of changed setting items, the error information, and the latest execution time with the display image ID associated with the job identification icon image selected in step S516 described above. Moreover, the thumbnail image and the finished image are also stored in association with the display image ID.

The process subsequently proceeds to step S519 where the executed-job manager 113 sets the number of re-executions associated with the display image ID to “0”, and the menu display controller 111 displays the menu screen 710 shown in FIG. 7. Then, the process ends.

On the other hand, if the user selects the “NO” button 1150 in step S517, the process ends without a display image ID being associated with the relevant job, and the menu display controller 111 switches the display back to the menu screen 710 shown in FIG. 7.

Step S520 is executed when the executed job is a re-executed job or when there is a job with identical settings. In step S520, the executed-job manager 113 updates the job history management list 115 by incrementing the number of re-executions set with respect to the relevant job.

In step S521, the menu display controller 111 displays a confirmation screen 1210 as shown in FIG. 12 on the user interface device 105. The confirmation screen 1210 displays a confirmation message 1220 reading “MARK ON LEFT IS ADDED TO JOB YOU EXECUTED. SELECT JOB WITH THIS MARK FROM JOB HISTORY LIST WHEN RE-EXECUTING JOB USING SAME SETTINGS.” and a diamond mark 1230 as a job identification icon image newly associated with the relevant job.

In this case, the executed-job manager 113 generates a new thumbnail image 1250, and the menu display controller 111 displays the image in addition to the job identification icon image 1230 and a finished image 1260.

Subsequently, when the user selects a confirm button 1240, the menu display controller 111 displays the menu screen 710 shown in FIG. 7 and ends the process.

In step S516 and step S517 described above, an input of selection of whether or not a job identification icon image as an image uniquely indicating the job is to be added is received from the user. Alternatively, an input of selection of whether or not there is a plan to re-execute the job may be received from the user. In that case, if the user selects that there is a plan to re-execute the job, a job identification icon image as an image uniquely indicating the relevant job may be added to the job, and a job identification icon image may not be added to a job that is not planned for re-execution.

In the above example, the individual job histories are arranged and displayed on the job history display screen 910 in FIG. 9 in step S505 based on the priority-order determination rule “descending number of re-executions”.

The priority-order determination rule may be selected from a “descending number of changed setting items” rule where jobs with more setting items having set values changed from the initial values are displayed with priority, a “prioritize job terminated due to error” rule where jobs not properly completed are displayed with priority, and a “descending order of latest execution time” rule where jobs with a shorter time period elapsed from the execution thereof are displayed with priority.

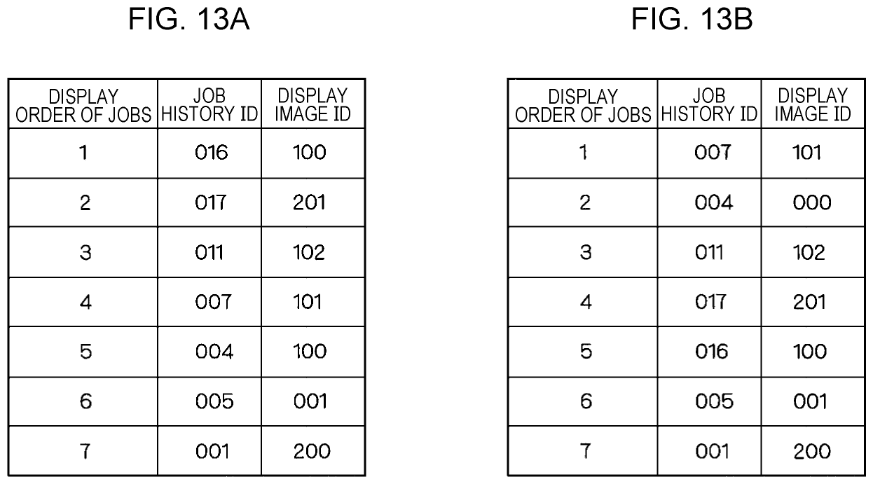

Furthermore, the priority-order determination rule may be a combination of multiple determination rules. For example, the “descending number of re-executions” rule may be set as a first priority, the “descending order of latest execution time” rule may be set as a second priority, and the “descending number of changed setting items” rule and the “prioritize job terminated due to error” rule may be set as disabled priority-order determination rules. FIG. 13A illustrates the display order of jobs sorted based on the job history management list 115 in FIG. 4 and the aforementioned priority-order determination rule.

In FIG. 13A, a job history ID “016” corresponding to a display image ID “100” and having the largest number of re-executions, which is “4”, is at the highest rank, followed by a job history ID “017” corresponding to a display image ID “201” and having “2” re-executions and the recent latest execution time.

Alternatively, with regard to the priority-order determination rule, for example, the “descending number of changed setting items” rule may be set as a first priority, the “prioritize job terminated due to error” rule may be set as a second priority, the “descending order of latest execution time” rule may be set as a third priority, and the “descending number of re-executions” rule may be set as a disabled priority-order determination rule. FIG. 13B illustrates the display order of jobs when the job history management list 115 in FIG. 4 is sorted in accordance with this priority-order determination rule.

In FIG. 13B, a job history ID “007” corresponding to a display image ID “101” and having the largest number of changed setting items, which is “8”, is at the highest rank, followed by a job history ID “004” corresponding to a display image ID “000” and “5” changed setting items, and then followed by a job history ID “011” corresponding to a display image ID “102” and having “3” changed setting items and a value “TRUE” as the terminated-due-to-error information at the third rank.

These priority-order determination rules may be selectable by the user from the sort-order display field 912 on the job history display screen 910 in FIG. 9, or may be preliminarily set by the mechanical manager of the multifunction apparatus 100.

Furthermore, the menu display controller 111 may only display a job associated with a job identification icon image, that is, a job regarded as being planned for re-execution, on the job history display screen 910, and may not display a job not associated with a job identification icon image, that is, a job not regarded as being planned for re-execution, on the job history display screen 910.

In the above exemplary embodiment, it is determined whether or not there is a job with identical set values, and if there is a job with identical set values, the job history ID of the relevant job is associated with the display image ID already associated with the job history ID having the identical set values. Therefore, if any of the set values varies, a different image is displayed on the job history display screen. Alternatively, as mentioned above, when a set value of a predetermined setting item is the same but a set value of a setting item other than the relevant setting item is different, a different image may be displayed. For example, if only a set value of a specific setting item preliminarily set by the mechanical manager is different, including a setting item changed by the user with high frequency, such as the number of copies or the destination, and a set value of a setting item changed by the user with low frequency is the same, the same image may be displayed.

As another alternative, when the user selects a certain executed job from the job history display screen, a function setting screen having the set values of the relevant executed job reflected therein may be displayed. In a case where the set values are changeable, the same image may be displayed on the job history display screen when only a set value of a setting item immediately changeable on the function setting screen is different. When a set value of a setting item not immediately changeable on the function setting screen is different, the image displayed on the job history display screen may be varied. In this case, a setting item that is immediately changeable is, for example, a setting item existing directly in a displayed region on the displayed function setting screen. In this case, the user does not have to perform an additional operation before changing a set value and may immediately change the set value. On the other hand, if an additional operation by the user is necessary before changing a set value, such as a scrolling operation or selection of another screen, the setting item is set as a setting item that is not immediately changeable.

First Specific Example of Operation

A specific example of operation in the multifunction apparatus 100 described above will be described below.

1. First, the mechanical manager of the multifunction apparatus 100 sets the priority-order determination rule for sorting jobs such that the “descending number of re-executions” rule is set as a first priority, the “descending order of latest execution time” rule is set as a second priority, and the “descending number of changed setting items” rule and the “prioritize job terminated due to error” rule are set as disabled priority-order determination rules (corresponding to FIG. 13A). Moreover, the mechanical manager sets images to be displayed on the job history display screen to job identification icon images alone.

2. A user logs in by operating the user interface device 105 of the multifunction apparatus 100, selects the “scan (mail-transmission)” function button 714 from the menu screen 710 shown in FIG. 7, sets a file format “PDF” and a transmission destination “Corporation A” as set values from a subsequently-displayed setting screen, places a document on the document tray, and presses the start button. Then, the document is scanned by the scanner 107 controlled by the job execution controller 112, the scanned data is converted into PDF data, and a mail is transmitted to Corporation A by the communication interface 104.

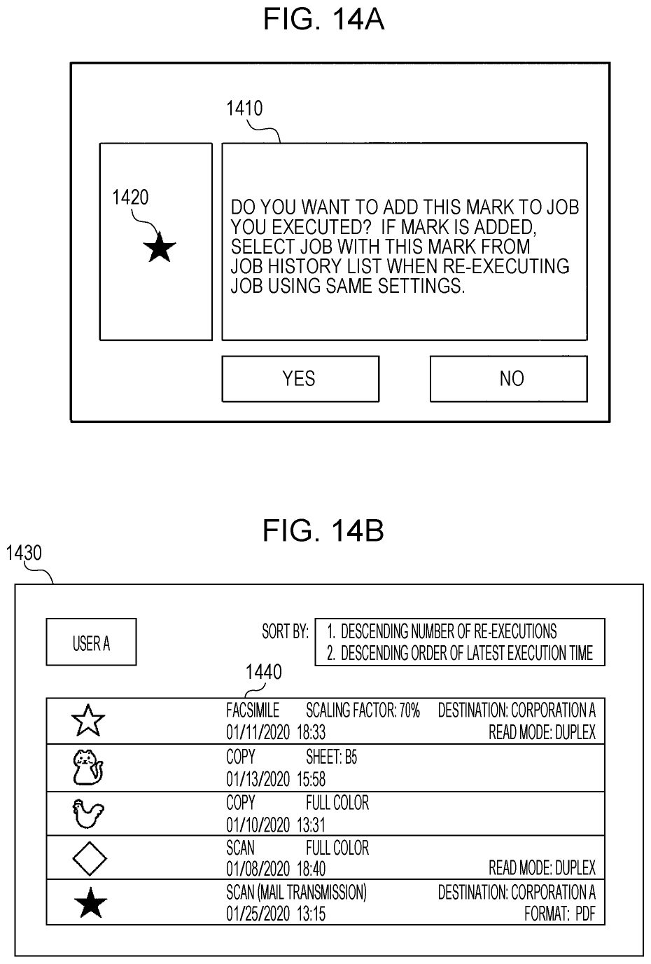

3. When the aforementioned job is to be completed, the user interface device 105 displays a confirmation message 1410 as shown in FIG. 14A. In this case, a green star image 1420 is displayed as a job identification icon image. The user remembers this image. Furthermore, a job history ID is associated with a display image ID associated with the green star image. The number of re-executions is set to “0”.

4. If the same user has to scan a document again and transmit a mail to Corporation A after a few days, the user selects the job history display button 718 in the menu screen 710, as shown in FIG. 7, displayed on the user interface device 105. Then, the menu display controller 111 displays a job history display screen 1430 as shown in FIG. 14B.

5. The user searches for the green star image from a job history display field 1440 in the job history display screen 1430 and selects the green star image. Then, the menu display controller 111 reads the set values of the job history associated with the green star image from the job history body 114, and reflects the read set values in the setting screen.

6. The user places the document on the document tray while checking the setting screen, and selects the start button. Then, similar to section 2 described above, the document is scanned by the scanner 107, the scanned data is converted into PDF data, and a mail is transmitted to Corporation A by the communication interface 104. In this case, the latest job history ID is associated with the display image ID associated with the star image. The number of re-executions is incremented so as to be set to “1”.

7. In order to scan a document and transmit a mail to Corporation A every few days, the user repeats the operation from section 4 to section 6 described above. In this case, since the “ascending number of re-executions” rule is set as the priority-order determination rule, the green star image as a job identification icon image is displayed at a higher rank on the list in the job history display field 1440 in the job history display screen 1430 shown in FIG. 14B.

Second Specific Example of Operation

First, the mechanical manager of the multifunction apparatus 100 sets the priority-order determination rule for sorting jobs such that the “descending number of changed setting items” rule is set as a first priority, the “prioritize job terminated due to error” rule is set as a second priority, the “descending order of latest execution time” rule is set as a third priority, and the “descending number of re-executions” rule is set as a disabled priority-order determination rule (corresponding to FIG. 13B). Moreover, the mechanical manager sets images to be displayed on the job history display screen to job identification icon images alone.

2. A user logs in by operating the user interface device 105 of the multifunction apparatus 100, selects the “copy” function button 712 from the menu screen 710 shown in FIG. 7, changes the set values for a total of three setting items, namely, “duplex” as the duplex/simplex print mode, “monochrome” as the color mode, and “two locations on left” as the stapling mode, from the subsequently-displayed copy function setting screen 810 shown in FIG. 8, places a document on the document tray, and presses the start button. As a result, the scanner 107 and the printer 106 are controlled by the job execution controller 112, so that the copied document is printed out.

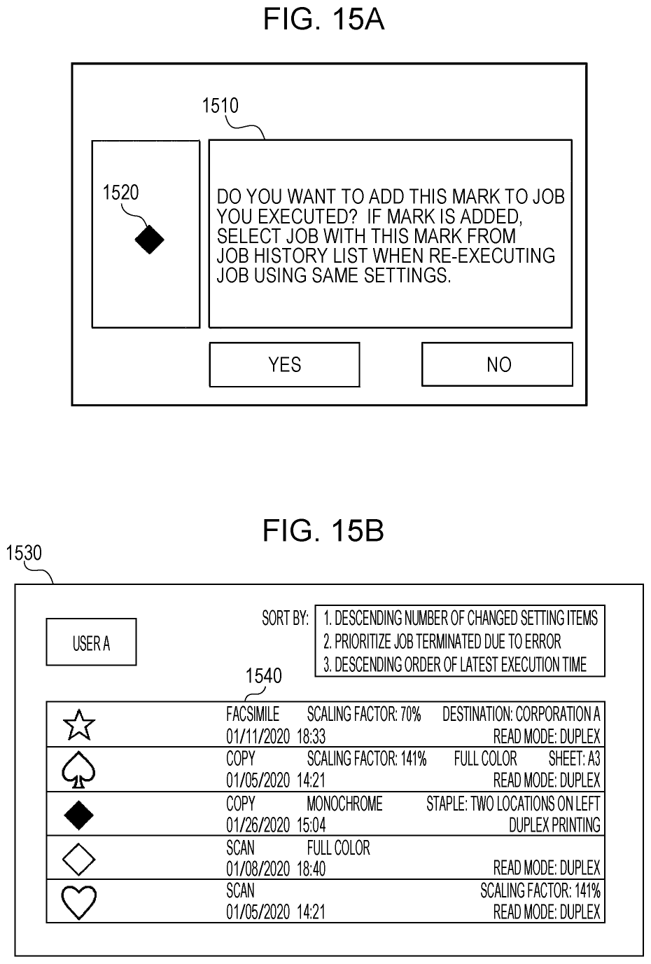

3. When the aforementioned job is to be completed, the user interface device 105 displays a confirmation message 1510 as shown in FIG. 15A. In this case, a red diamond image 1520 is displayed as a job identification icon image. The user remembers this image. Furthermore, a job history ID is associated with a display image ID associated with the diamond image. The number of changed setting items is set to “3”.

4. In a case where the same user tries to re-execute copying a few days later with the same settings except for the number of copies, the user selects the job history display button 718 in the menu screen 710, as shown in FIG. 7, displayed on the user interface device 105. Then, the menu display controller 111 displays a job history display screen 1530 as shown in FIG. 15B.

5. The user searches for the red diamond image from a job history display field 1540 in the job history display screen 1530 and selects the red diamond image. Then, the menu display controller 111 reads the set values of the job history associated with the red diamond image from the job history body 114, and reflects the read set values in the setting screen.

6. The user changes the setting item for the “number of copies” from “1” to “5” from the setting screen, places a document on the document tray, and presses the start button. As a result, the scanner 107 and the printer 106 are controlled by the job execution controller 112, so that five copies of the copied document are printed out.

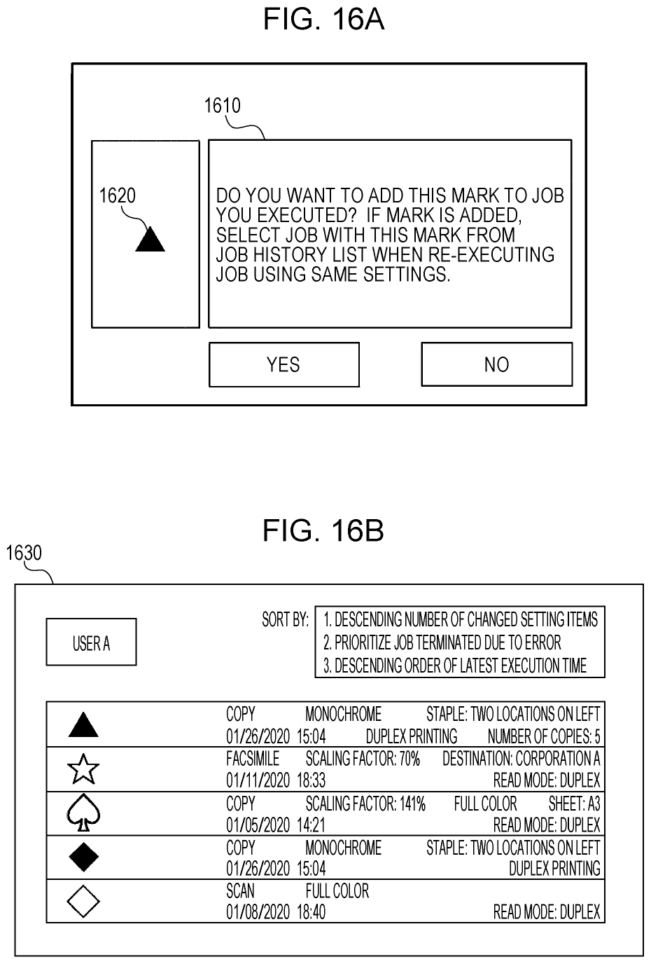

7. When the aforementioned job is to be completed, the user interface device 105 displays a confirmation message 1610 as shown in FIG. 16A. Because the set values have been further changed as a result of the above-described operation, the job is treated as a job different from section 3 described above, such that a red triangle image 1620 is displayed as a job identification icon image. The user remembers this image. Furthermore, a job history ID is associated with a display image ID associated with the red triangle image. The number of changed setting items is set to “4”.

8. When the user selects a job history display button 618 from a menu screen 610 displayed on the user interface device 105 so as to cause a job history display screen 1630 as shown in FIG. 16B to be displayed, since the priority-order determination rule for sorting jobs is set such that the “descending number of changed setting items” rule is set as a first priority, the executed job associated with the red triangle image is displayed at a higher rank than the executed job associated with the red diamond image or other executed jobs whose number of changed setting items is “3”.

Third Specific Example of Operation

1. First, the mechanical manager of the multifunction apparatus 100 sets the priority-order determination rule for sorting jobs similarly to the above-described first specific example of operation such that the “descending number of re-executions” rule is set as a first priority, the “descending order of latest execution time” rule is set as a second priority, and the “descending number of changed setting items” rule and the “prioritize job terminated due to error” rule are set as disabled priority-order determination rules. Moreover, the mechanical manager sets images to be displayed on the job history display screen to a combination of job identification icon images and thumbnail images serving as sample images of reduced document images when the corresponding jobs are executed.

2. A user logs in by operating the user interface device 105 of the multifunction apparatus 100, selects the “scan (mail-transmission)” function button 714 from the menu screen 710 shown in FIG. 7, sets a file format “PDF” and a transmission destination “Corporation A” as set values from a subsequently-displayed setting screen, places a document on the document tray, and presses the start button. Then, the document is scanned by the scanner 107 controlled by the job execution controller 112, the scanned data is converted into PDF data, and a mail is transmitted to Corporation A by the communication interface 104.

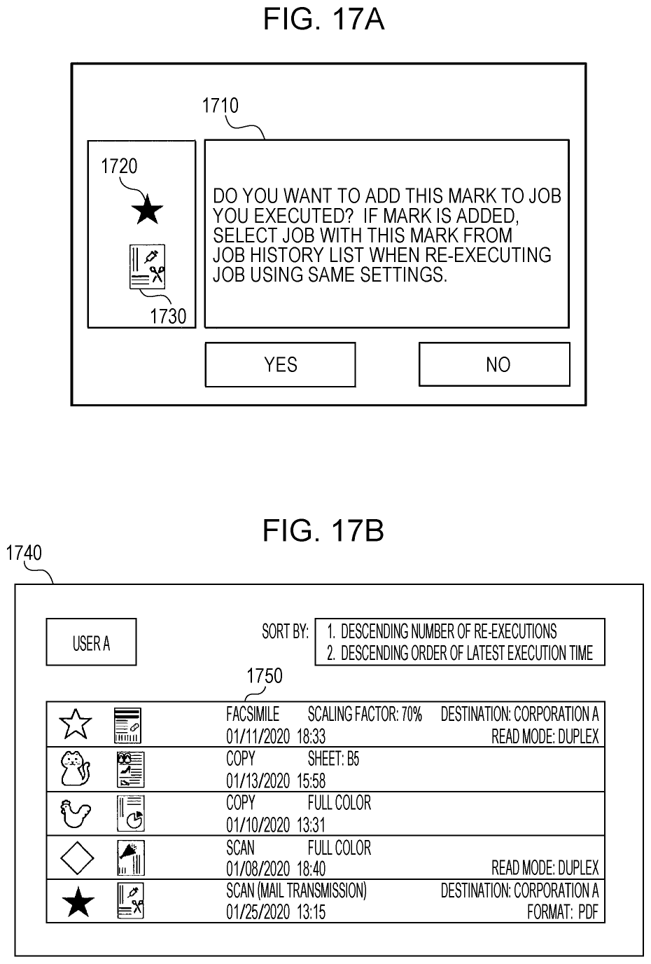

3. When the aforementioned job is to be completed, the user interface device 105 displays a confirmation message 1710 as shown in FIG. 17A. In this case, a green star image 1720 as a job identification icon image and a thumbnail image 1730 of the document scanned in section 2 described above are displayed. The user remembers these images. Furthermore, the thumbnail image of the scanned document and a job history ID are associated with a display image ID associated with the green star image. The number of re-executions is set to “0”.

4. If the same user has to scan a document again and transmit a mail to Corporation A after a few days, the user selects the job history display button 718 in the menu screen 710, as shown in FIG. 7, displayed on the user interface device 105. Then, the menu display controller 111 displays a job history display screen 1740 as shown in FIG. 17B.

5. The user searches for the green star image and the thumbnail image from a job history display field 1750 in the job history display screen 1740 and selects the green star image and the thumbnail image. Then, the menu display controller 111 reads the set values of the job history associated with the green star image and the thumbnail image from the job history body 114, and reflects the read set values in the setting screen.

6. The user places the document on the document tray while checking the setting screen, and selects the start button. Then, similar to section 2 described above, the document is scanned by the scanner 107, the scanned data is converted into PDF data, and a mail is transmitted to Corporation A by the communication interface 104. In this case, the latest job history ID and a thumbnail image of the newly-scanned document are associated with the display image ID associated with the star image. The number of re-executions is incremented so as to be set to “1”.

7. In order to scan a document and transmit a mail to Corporation A every few days, the user repeats the operation from section 4 to section 6 described above. In this case, since the “ascending number of re-executions” rule is set as the priority-order determination rule, the green star image as a job identification icon image and the thumbnail image are displayed at a higher rank on the list in the job history display field 1750 in the job history display screen 1740 shown in FIG. 17B.

In the above exemplary embodiment, each of the jobs constituting the job history display screen is provided with a job content display field in addition to a job identification icon image, and principal set values of the relevant job are displayed. Alternatively, the job history display screen may display job identification icon images alone, such that when the user selects any of the job identification icon images, a thumbnail image, a finished image, principal set values, and the latest job execution time that are associated with the selected job identification icon image may be displayed in a pop-up fashion.

Furthermore, in the above exemplary embodiment, the job identification icon images are randomly associated with the corresponding jobs by the executed-job manager 113. Alternatively, when a job is executed, a list of job identification icon images unassociated with job histories may be displayed, and the user may select a desired job identification icon image from the list and associate the selected job identification icon image with the executed job.

Moreover, in the above exemplary embodiment, a case where all set values completely match is described as being a case where the set values are determined as being “identical”. Alternatively, for example, if only the number of copies is changed, it may be determined that the settings are identical. In that case, different icons are not allocated to jobs with identical set values with respect to setting items other than the number of copies. With regard to setting items with set values having a high possibility of being changed by the user for each job, such as a destination number for facsimile transmission, a destination mail address for scanned data, and a directory path, in addition to the number of copies, such setting items may be excluded from setting items subjected for determination of whether or not the set values are “identical”. Furthermore, the mechanical manager or the user may select which of the setting items is to be excluded.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising:
a processor configured to
perform control for displaying executed jobs as a job history list together with images uniquely indicating the jobs, such that identical images are displayed for jobs with identical set values with respect to a predetermined setting item, each of the executed jobs constituting a job history.

2. The image processing apparatus according to claim 1, wherein the processor is configured to perform the control such that, as the image uniquely indicating each job, an image used for a history of a different job is prohibited from being displayed for a history of the job.

3. The image processing apparatus according to claim 1, wherein the processor is configured to perform the control such that the displayed image uniquely indicating each job is randomly selected from a plurality of different images without being redundant with another image.

4. The image processing apparatus according to claim 2, wherein the processor is configured to perform the control such that the displayed image uniquely indicating each job is a combination of a plurality of images.

5. The image processing apparatus according to claim 3, wherein the processor is configured to perform the control such that the displayed image uniquely indicating each job is a combination of a plurality of images.

6. The image processing apparatus according to claim 4, wherein the plurality of images further include at least one of a sample image obtained by reducing a document when the job is executed and an image obtained by abstracting a setting content of the job.

7. The image processing apparatus according to claim 5, wherein the plurality of images further include at least one of a sample image obtained by reducing a document when the job is executed and an image obtained by abstracting a setting content of the job.

8. The image processing apparatus according to claim 1, wherein the processor is configured to perform the control such that a job that is re-executed for a larger number of times is displayed with priority in the job history list.

9. The image processing apparatus according to claim 2, wherein the processor is configured to perform the control such that a job that is re-executed for a larger number of times is displayed with priority in the job history list.

10. The image processing apparatus according to claim 3, wherein the processor is configured to perform the control such that a job that is re-executed for a larger number of times is displayed with priority in the job history list.

11. The image processing apparatus according to claim 4, wherein the processor is configured to perform the control such that a job that is re-executed for a larger number of times is displayed with priority in the job history list.

12. The image processing apparatus according to claim 1, wherein the processor is configured to perform the control such that a job that has more setting items with set values changed from initial values is displayed with priority in the job history list.

13. The image processing apparatus according to claim 1, wherein the processor is configured to perform the control such that a job that is not properly completed is displayed with priority in the job history list.

14. The image processing apparatus according to claim 1, wherein the processor is configured to perform the control such that a job with a shorter time period elapsed from execution of the job is displayed with priority in the job history list.

15. The image processing apparatus according to claim 1, wherein the processor is configured to perform the control such that, every time a job is executed, selection of whether or not to add an image uniquely indicating the job is received from a user.

16. The image processing apparatus according to claim 15, wherein the processor is configured to perform the control such that, every time a job is executed, selection of whether or not the user has a plan to re-execute the job is received from the user, and if the job is planned to be re-executed, the job is displayed with an image uniquely indicating the job.

17. The image processing apparatus according to claim 16, wherein the processor is configured to perform the control such that only the job planned to be re-executed is displayed in the job history list.

18. The image processing apparatus according to claim 15, wherein the processor is configured to perform the control such that, every time a job is executed, selection of whether or not a user has a plan to re-execute the job is received from the user, and if the job is not planned to be re-executed, the job is prohibited from being displayed with an image uniquely indicating the job.

19. The image processing apparatus according to claim 18, wherein the processor is configured to perform the control such that the job not planned to be re-executed is prohibited from being displayed in the job history list.

20. A non-transitory computer readable medium storing a program causing a computer to execute a process, the computer constituting an image processing apparatus including a processor, the process comprising:
performing control for displaying executed jobs as a job history list together with images uniquely indicating the jobs, such that identical images are displayed for jobs with identical set values with respect to a predetermined setting item, each of the executed jobs constituting a job history.
